(19) United States
(12) Patent Application Publication
(10) Pub. No.: US 2005/0256767 A1
(43) Pub. Date: Nov. 17, 2005

(54) Method of developing customer acquisition and loyalty marketing programs

(76) Inventor: Elliot P. Friedman, Montecito, CA (US)

Correspondence Address: J. Harrison Colter;Suite 3750, 445 South Figueroa Street, Los Angeles, CA, 90071, US

(21) Appl. No.: 10/843,044

(22) Filed: May 11, 2004

(51) Int. Cl. G06F 17/60

(52) U.S. Cl. 705/14

(57) ABSTRACT

A method for developing a comprehensive and integrated corporate marketing program to increase new customer acquisition and customer loyalty for consumer services corporations is disclosed. The method involves an integrated set of marketing, database and communication steps. The marketing portion of the process involves researching the given marketplace, creating branding tools, and developing loyalty-based products and programs in support of the marketing. The database portion of the process includes creation of a new database, populating the database with data from a variety of sources, and using the data in the new database to deliver the products and programs. The communication process steps include researching existing and potential communication channels, developing and selecting appropriate channels for the delivery of the products and programs, creating promotional and informational materials, and acquiring third party media to deliver the products and programs.

### BACKGROUND

This invention relates to a method for developing comprehensive and integrated marketing programs to increase new customer acquisition and customer loyalty for consumer services corporations (financial services, telecommunications, airlines, retail etc.), and particularly to a method of increasing new customer acquisition and loyalty through a comprehensive and integrated program of marketing, sales, product development, communication channel development, and information technology.

In many world markets, competition among consumer services companies is keen and companies have particular difficulty in winning and maintaining the loyalty of customers. In the United States and Europe, consumer services companies have responded to the customer retention problem by implementing reward-based programs to provide incentives to customers to continue to do business with the company and increase their level of spending. Two common examples of these reward programs are airline and credit card point reward programs where points are accumulated based on the amount of money a consumer spends and these points are redeemable by the consumer for gifts, travel, or other such benefits.

However, reward loyalty programs are limited in scope and address only a small portion of a company's overall customer loyalty issue. They also provide limited benefits to the related goal of new customer acquisition. An example of the limited scope of prior programs is that reward programs don't integrate with the marketing programs that develop and maintain a company's brand image. This lack of integration significantly limits the effectiveness of the programs and impairs the company's ability to achieve goals for increased loyalty and new customer acquisition, as a customer's loyalty or decision to purchase services from a company (become a customer) is related to their affinity to a consumer services company's brand. Additionally, the reward program should become a significant component of the program to enhance the company's brand image.

Other examples of the limitation of prior reward programs is the lack of integration with new product development, salesperson incentive programs, customer database and management systems, sales strategy, communication development or brand spokesman strategy. This lack of integration significantly limits the effectiveness of these reward programs in achieving the goals of increased customer loyalty and new customer acquisition. The lack of a comprehensive and integrated program to increase customer loyalty and new customer acquisition can render a company's overall marketing efforts disjointed and unfocused in achieving these corporate goals.

A typical large consumer services company has many departments and each has its own agenda, goals, and plans. Reward programs are a recent phenomena and have evolved as a temporary fix to customer loyalty issues. The programs typically developed ad hoc, without integration to the company's other programs and business processes. Furthermore, the goal of increased customer loyalty has been separated from new customer acquisition and “pigeonholed” as a simple rewards program; in fact, the method for achieving the two goals of increased new customers and customer loyalty have similar strategies, programs, and integration.

Developing a comprehensive customer acquisition and loyalty program and integrating the program with a company's marketing, IT, sales, communication channel development, product development, and other systems is impossible without a specific integrated and comprehensive marketing program development method that is specifically focused at significantly increasing a company's new customer acquisition and customer loyalty. However, thus far no such method has existed. Thus, many consumer services companies would benefit from a new method for creating an effective new marketing program to increase customer acquisition and loyalty and integrating the program with their ongoing business activities.

### SUMMARY

According to the present invention, a method is provided to create, implement, coordinate, and maintain the marketing activities of a consumer services company to maximize new customer acquisition and customer loyalty. The method permits a consumer services company to implement a comprehensive and integrated process of marketing, communication channel development, sales, product development and programs (including rewards), and information technology to communicate and deliver new products and programs to customers and potential customers. The new products and programs provide valuable incentives to customers, increasing new customer acquisition and increasing customer loyalty to the consumer services company both in the short-term and long-term.

The method of the present invention involves the implementation of multiple initiatives to develop a comprehensive new customer acquisition and loyalty program and integrate the program into the standard programs of the consumer services company. According to the invention, a market research program is used to define the company's major competitors. Customers and potential customers are interviewed about their needs and desires, how consumer services companies fulfill these needs and desires, and their degree of loyalty to any one consumer services company. The opportunities in the current market are analyzed by examining market growth and the level of competition in the market, and this market research is summarized by gathering the resulting data in graphs, charts, and text.

Once the market research is complete, a market report is produced, collecting the results of the research. This report is used to generate a target strategic position for the company. The target position is determined with respect to the market and the company's customer relationships. Multiple strategic positions are possible for different segments of the target market. The method of the present invention involves steps for attaining the target position for the company.

Branding tools are developed for the company to communicate to the public the company's message in attaining the target strategic position in the market. These branding tools may include a brand spokesperson, tag lines, logos, musical signature, promotions and other advertising methods. A set of new products and programs (including reward programs) is developed around the new message and corporate positioning, for the purpose of increasing new customer acquisition and customer loyalty.

New information technology and operations systems are developed and implemented to support the new products and programs, regulating functions such as program enrollment, accrual of points and benefits, redemption of offerings, and customer service. Corporate sponsors (marketing partners) may participate in the development of new products, reward programs, and information technology as needed.

To facilitate marketing of the new products and programs to potential customers, a new prospect database is created using data from customer referrals, acquired lists of potential customers, media outreach activities, and company seminars. Sales strategies are developed for marketing the new products and programs to the public. The new marketing initiatives are integrated into the company's existing products and programs so that the company's sales, operations, and customer service can accommodate both the existing products and programs and any new products and programs.

A loyalty database is created to facilitate implementing of the new products and programs. The core customer data from the company's customer database is retrieved by mapping the customer database and specifying the customer data that is needed. An interface program and a transfer program are developed and used to transfer the core customer data from the customer database into the new loyalty database. Additional customer data that is needed but not found in the customer database is gathered by contacting customers.

The core customer data is combined with the additional customer data to create a set of integrated customer data, which is transferred into the loyalty database using the transfer and interface programs. The loyalty database is then used to implement the loyalty-oriented products and programs, distributing information and materials to the customers using the communications channels described hereafter. The loyalty database is also synchronized with the company's other databases so that the set of integrated customer data is easily accessible for management reporting, marketing, product development, sales, market research, and other corporate uses, and is updated as the company's other databases are updated.

To increase the effectiveness of the present invention, the company's communication channels are evaluated and updated. The available channels of communication in the company's market are identified, and the effectiveness of the company's ongoing use of the communication channels is reviewed and examined in relation to the needs created by the new products and programs. The appropriate communication channels are selected and developed for the new products and programs, as well as long term use to support new customer acquisition and loyalty programs.

This is done by developing the capabilities and expertise of the Company to exploit certain communication channels owned by third party promotional media or by the Company developing new communication channels or media that it owns. After the selected communication channels are developed, they are used to inform the company's customers and potential customers of the loyalty-based products and programs. The use of the selected communication channels to promote the new products and programs is coordinated with the company's ongoing use of the communication channels to minimize customer confusion and create a unified communication program.

The method for developing a comprehensive and integrated marketing program to increase new customer acquisition and customer loyalty can be implemented directly by a consumer services company or provided by a third party vendor with expertise in the field, on an outsource basis or consulting basis, or a hybrid system could be used. As new information on the successes and failures of the loyalty-based products and programs is gathered, the steps of the process described previously are repeated as needed to increase effectiveness and compensate for competitor and market changes.

### BRIEF DESCRIPTION OF THE DRAWINGS

Other features and advantages of the present invention will be apparent from reference to the following Detailed Description taken in conjunction with the accompanying Drawings, in which:

FIG. 1 is a flowchart of the basic process of the present invention;

FIG. 2 depicts the process of developing loyalty-based branding tools and new products and programs;

FIG. 3 depicts the process of building the loyalty database, which contains the customer information used in marketing the new loyalty-based products and programs; and

FIG. 4 depicts the evaluation and development of communication channels to inform customers and potential customers of the new loyalty-based products and programs.

### DETAILED DESCRIPTION

According to the present invention, a method is provided to create, implement and coordinate the marketing activities of a consumer services company to increase new customer acquisition and customer loyalty. These marketing activities implement a set of new products and programs designed to increase customer satisfaction based on market research. The marketing activities are integrated with a new customer database and selected communication channels to deliver the new products and programs to the company's customers and potential customers. The method allows a consumer services company to implement a customer loyalty program that is fully integrated with the company's core business and target markets.

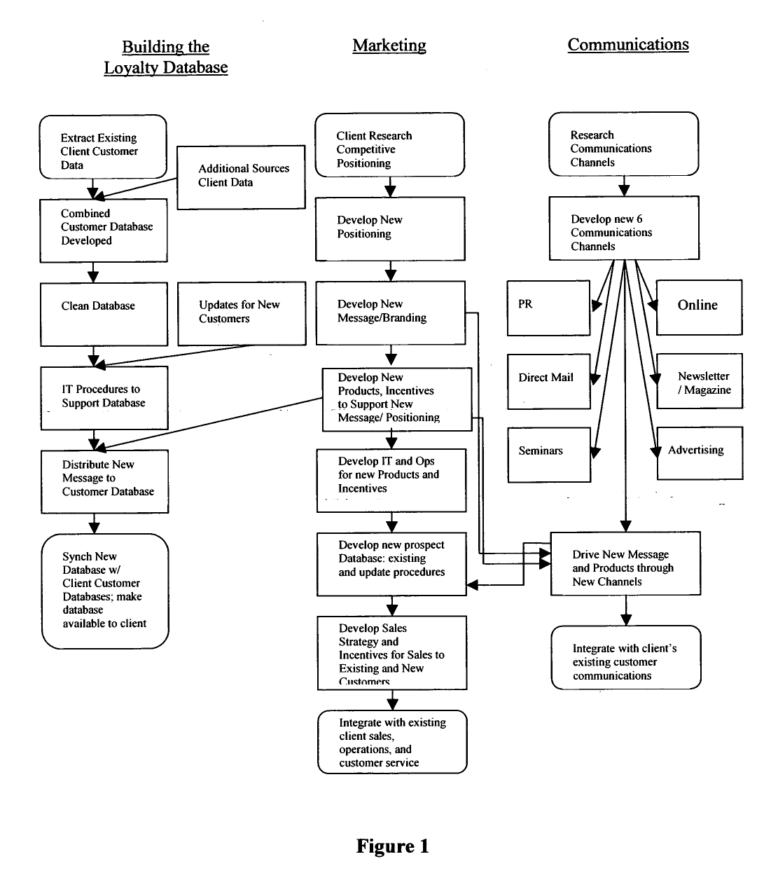

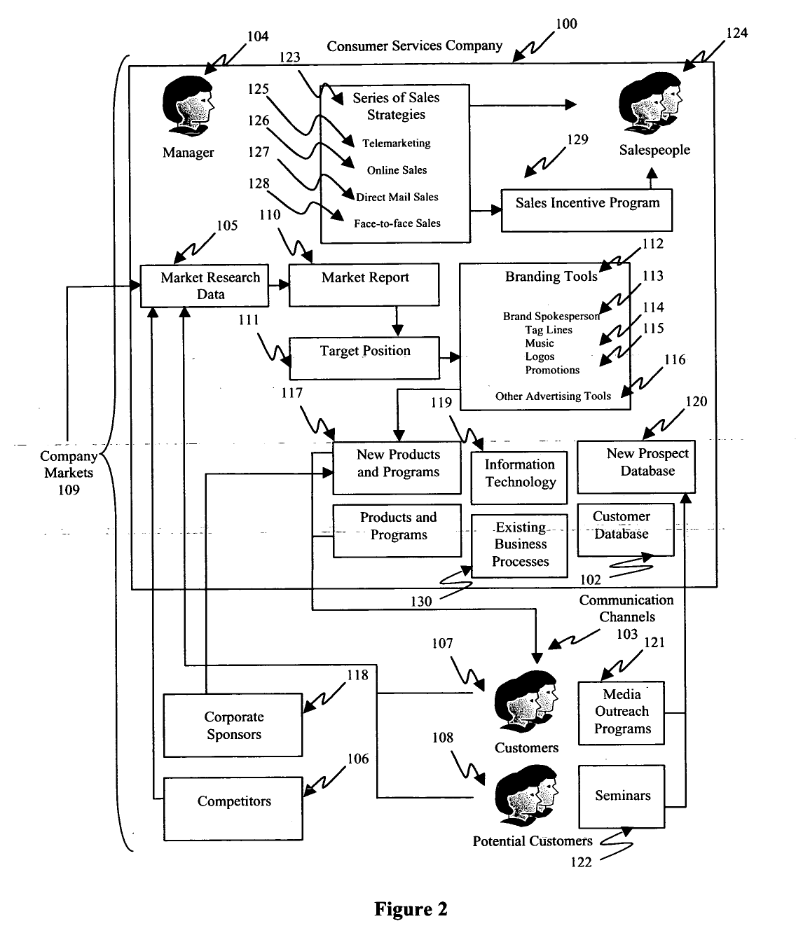

The method of the present invention operates in a consumer services company 100, as depicted in FIGS. 1 and 2. Consumer services companies 100 useful in the practice of the present invention typically implement products and programs 101 using a customer database 102 and communication channels 103.

According to the present invention, a manager 104 gathers market research data 105 to assess the competitive positioning of the consumer services company 100 as depicted in FIG. 2. This manager 104 may be an individual or a group that is employed by the consumer services company 100 or that acts as an independent vendor. The manager 104 may also comprise a hybrid of company employees and independent contractors.

To gather the market research data 105, the manager 104 first identifies its major competitors 106. Second, the manager 104 conducts interviews with customers 107 of the consumer services company 100 and with potential customers 108 to determine the customers' and potential customers' needs and desires, how the customers 107 and potential customers 108 fulfill those needs and desires, how competitors 106 fulfill these needs and desires, and the level of loyalty that the customers 107 and potential customers 108 have to the consumer services company 100 or one of its competitors 106. Third, the manager 104 analyzes the level of opportunity for growth in the company markets 109 by examining the growth of the company markets 109 and the growth the competitors 106 have experienced in the company markets 109. Fourth, the manager 104 summarizes the market research data 105 using graphs, tables, text, and the other reporting methods known in the art.

The manager 104 uses the market research data 105 to create a market report 110, and the manager 104 analyzes this market report 110 to generate a target position 111 for the consumer services company 100 in the company markets 109. This target position 111 represents the position in the company markets 109 in relation to competitors 106 and relations with customers 107 that the consumer services company 100 seeks to attain.

As depicted in FIG. 2, the manager 104 uses the target position 111 to develop a set of branding tools 112. The branding tools 112 may be those known in the art, such as a brand spokesperson, taglines, and /or musical signatures 113, logos 114, promotions 115, and other advertising tools 116. The branding tools 112 are designed to facilitate the process of the consumer services company 100 reaching the target position 111.

The manager 104 develops a set of new products and programs 117 designed to act as incentives for the customers 107 and potential customers 108 to invest in and remain loyal to the consumer services company 100. These new products and programs 117 work together with the branding tools 112 to cause the consumer services company 100 to reach the target position 111. The set of new products and programs 117 may include reward programs based on the level of spending by a customer 107 in the consumer services company 100, whole new lines of business (asset management or credit cards for insurance companies), or a redefinition of existing products (bundled telecommunications services). New programs might include direct sales of car insurance, special web service and club for VIP airline customers, financial seminars for bank customers, or other similar programs as are known in the art. The manager 104 also seeks to acquire corporate sponsors 118, that is, third party marketing partners and individuals that provide a portion of the new products and programs 117, as they are needed.

The manager 104 then coordinates the development of information technology 119 necessary to implement the new products and programs 117. The manager 104 may develop this information technology 119, or it may be developed in part by the consumer services company 100 or the corporate sponsors 118, as appropriate for the specific new products and programs 117. The information technology comprises such things as applications, web-based clients, and servers. The information technology 119 tracks program enrollment, accrual of points, redemption of coupons and accrued points, as well as provides customer service and other aspects of the new products and programs 117.

Next, the manager 104 creates a new prospect database 120, a database of information about potential customers 108 as depicted in FIG. 2. The information in the new prospect database 120 may come from referrals from customers 107, acquired lists of potential customers 108, media outreach programs 121, seminars 122, or other sources as are known in the art. The manager 104 structures the new prospect database 120 so that it may interact with the other databases of the consumer services company 100.

The manager 104 develops a series of sales strategies 123 that the salespeople 124 of the consumer services company 100 may use to market and sell the new products and programs 117. These salespeople 124 may be employees of the consumer services company 100, independent agents, or third party entities specializing in sales. The series of sales strategies 123 may include telemarketing 125, online sales 126, direct mail sales 127, face-to-face sales 128, or other sales strategies as are known in the art. The manager 104 also develops a sales incentives program 129 to reward salespeople 124 for successfully implementing the new products and programs 117. The sales incentives program 129 may include commissions, rewards based on sales volume, and other rewards based on the loyalty and effectiveness of the salespeople 124.

The manager 104 must integrate the branding tools 112, information technology 119, and the new products and programs 117 with the existing business processes 130 of the consumer services company 100. This integration allows the consumer business company 100 to manage the new products and programs 117 together with the existing business processes 130 to reach the target position 111 in the company markets 109. This integration may include training for salespeople 124 and adding data from the sales incentives program 129 to databases used by the consumer services company 100, as well as other known integration techniques.

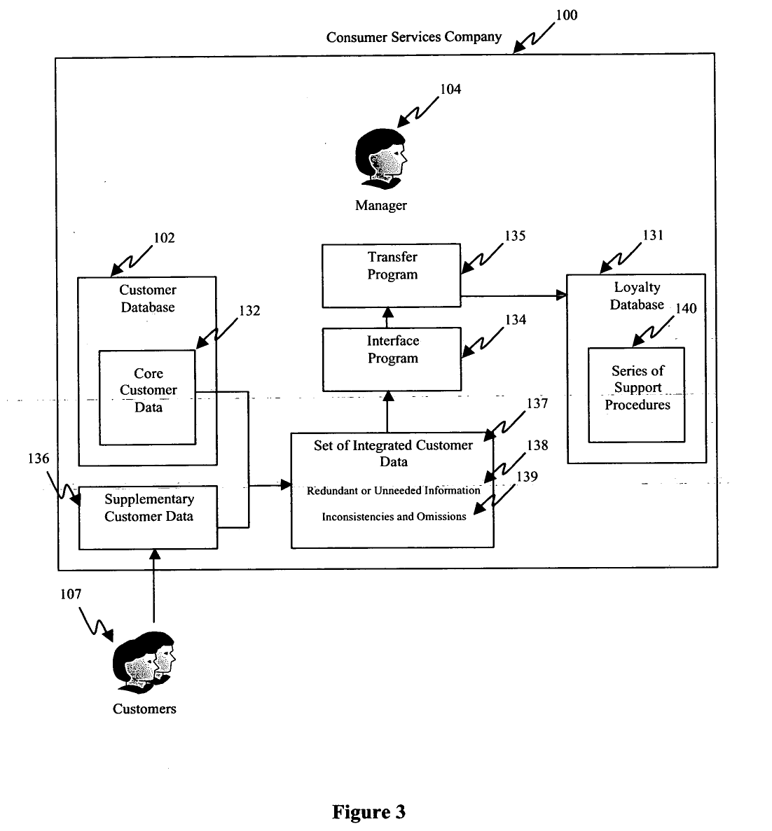

The manager 104 also develops a loyalty database 131 for the consumer services company 100 to track the participation of customers 107 in the new products and programs 117 in a series of steps as depicted in FIG. 3. This development can be done concurrently or subsequent to the steps for developing branding tools 112 and new products and programs 117 described above.

The manager 104 first retrieves core customer data 132 from the customer database 102 of the consumer services company 100. To accomplish this, the manager 104 maps the data structure of the customer database 102, finding the places in the data structure where the core customer data 132 is kept. The manager 104 develops, or has developed by a third party, an interface program 134 and a transfer program 135 to extract the core customer data 132 from the customer database 102. The manager 104 also gathers supplementary customer data 136, that is, data deemed necessary by the manager 104 that is not found in the core customer data 132, through direct or indirect contact with customers 107.

The manager 104 combines the core customer data 132 with the supplementary customer data 136 as depicted in FIG. 3, creating a set of integrated customer data 137. The manager 104 enters this set of integrated customer data 137 into the loyalty database 131, using the interface program 134 and the transfer program 135. Redundant and unneeded information 138 is stripped out of the loyalty database 131. The manager 104 also searches the loyalty database 131 for inconsistencies and omissions 139, resolving the inconsistencies and omissions 139 through contact with the customers 107.

The manager 104 develops, or has developed by a third party, a process for updating the loyalty database 131 so that it remains consistent with the core customer data 132 in the customer database 102. Optimally, this updating process is largely automated using techniques known in the database art. The manager 104 also develops, or has developed by a third party, a series of support procedures 140 to keep the loyalty database 131 secure and ordered. These procedures may include database performance monitoring, website tracking and redesign, network performance monitoring, redundancy and data integrity checking, and database security, as well as other such processes known in the art.

The set of integrated customer data 137 is then used to disseminate the new products and programs 117, as well as branding tools 112, to the customers 107. The manager 104 ensures that the loyalty database 131 is regularly updated so that it remains synchronized with the customer database 102, the new prospect database 120, and any other databases used by the consumer services company 100.

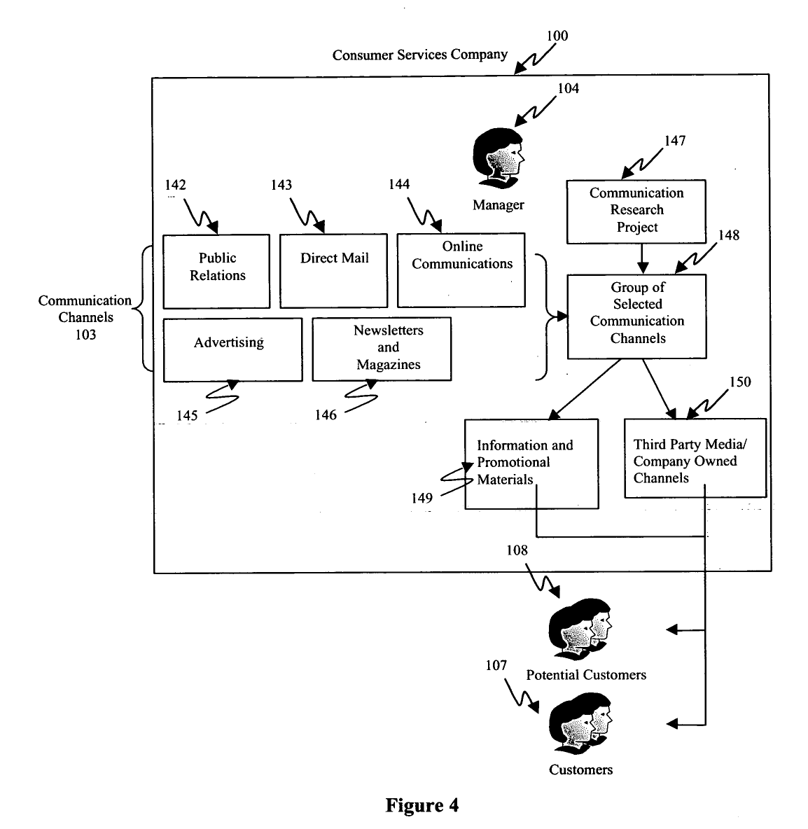

The manager 104 also updates the use of communication channels 103 by the consumer services company 100 in a series of steps depicted in FIG. 4. This updating can be done concurrently or subsequent to the steps for developing the loyalty database 131, branding tools 112, and new products and programs 117 described above. Possible communications channels include public relations 142, direct mail 143, seminars 122, online communications 144, advertising 145, and newsletters and magazines 146, or other channels known in the art. To accomplish this, the manager 104 conducts a communication research project 147 that identifies all communication channels 103 available in the company markets 109, reviews the effectiveness of the use of each of the communication channels 103 in the past, and examines the new products and programs 117 to evaluate how they can be implemented through the communication channels 103.

The manager analyzes the results of the communication research project 147, and chooses from the communication channels 103 a group of selected communication channels 148 necessary for implementation of the new products and programs 117. The manager 104 develops the group of selected communication channels 148 to implement the new products and programs 117. The manager 104 does this by creating information and promotional materials 149 to be disseminated through the group of selected communication channels 148 and by developing the long term capability to exploit third party media 150. The manager may also develop company owned communications channels (company only use) and media (general public use including company).

The group of selected communication channels 148 are used to inform customers 107 and potential customers 108 of the new products and programs 117. The group of selected communication channels 148 is integrated with the ongoing use of the communication channels 103 by the consumer services company 100 to minimize the confusion of customers 107 from varying messages and media.

The method of the present invention allows a consumer services company concerned with customer loyalty and market position to resolve these concerns through a comprehensive program designed to increase new customer acquisition and loyalty. Thus, the present invention has several advantages over the prior art. Although embodiments of the present invention have been described, various modifications and changes may be made by those skilled in the art without departing from the spirit and scope of the invention.

1. A method for developing a comprehensive and integrated corporate marketing program to increase new customer acquisition and customer loyalty for a consumer services company comprising the steps of:
conducting market research by:
defining the company's major competitors;
interviewing customers and potential customers about customer needs, how the customer fulfills those needs, how competitors fulfill those needs, and the customer's loyalty to the company or one of its competitors;
analyzing current market opportunities by examining growth in the company's markets and the competition in those markets; and
summarizing the gathered data through a predetermined set of measures, graphs, and text;
producing a market report that includes any results from the market research;
analyzing the market report to generate a target position for the company with respect to the company's market and the company's customer relationships;
developing a predetermined set of branding tools to cause the company to reach the target position;
developing a set of products and programs that support the set of branding tools and that facilitate the company in obtaining the target position;
acquiring corporate sponsors;
developing information technology and operation systems to support the set of products and programs;
coordinating the development of information technology and operation systems by the company and corporate sponsors;
creating a new prospect database containing information about potential customers, the new prospect database being derived from customer referrals, acquired lists of potential customers, media outreach, and company seminars;
developing a set of sales strategies for the set of products and programs, including telemarketing, online, direct mail, and face-to-face sales, with sales incentives;
integrating the set of products and programs into the company's existing products and programs;
retrieving a set of core customer data from a first database used by the company by
mapping the data structure of the first database;
specifying the customer data in the data structure of the first database; and
developing an interface program and a transfer program to move the customer database from the first database to a second database;
gathering a set of supplementary customer data through direct or indirect contact with customers;
combining the set of core customer data with the additional customer data to create an set of integrated customer data;
entering the set of integrated customer data into the second database using the interface program and the transfer program;
removing from the integrated set of customer data all redundant or unneeded entries and information;
identifying inconsistencies and missing information in the integrated set of customer data and resolving the inconsistencies and collecting the missing data through customer contact;
developing a process for updating the second database so that the set of integrated customer data contained in the second database remains consistent with the customer data in the first database;
developing a series of support procedures to keep the second database secure and ordered;
using the integrated set of customer data to disseminate the set of products and programs created for the company to customers and potential customers; linking the second database with the first database and all other customer databases to ensure data integrity as the respective databases are updated;
researching the company's communication activities by:
identifying communication channels available in the company's marketplace;
reviewing the effectiveness of previous use of the identified communication channels in the past; and
examining the communication channels in relation to the needs of the set of products and programs;
selecting at least one of the identified communication channels;
developing the selected communication channel by producing promotional or informational materials for the channel or developing the capability to utilize third party media;
using the selected communication channel to inform current and potential customers of the set of products and programs; and
coordinating the use of the selected communication channel with existing company use of the selected communication channel and other communication channels.

2. A method for developing a comprehensive and integrated corporate marketing program to increase new customer acquisition and customer loyalty for a consumer services company comprising the steps of:
conducting market research about the company and producing a market report of the results;
analyzing the market report to generate a target position for the company with respect to the company's market and the company's customer relationships;
developing a predetermined set of branding tools to cause the company to reach the target position;
developing a set of products and programs that support the set of branding tools and that facilitate the company in obtaining the target position;
developing a set of sales strategies for the set of products and programs;
integrating the set of products and programs into the company's existing products and programs;
retrieving a set of core customer data from a first database used by the company;
creating a set of integrated customer data in a second database;
using the integrated set of customer data to disseminate the set of products and programs created for the company to customers and potential customers;
selecting a communication channel to inform current and potential customers of the set of products and programs; and
coordinating the use of the selected communication channel with existing company use of the selected communication channel and other communication channels.

3. The method of claim 2 wherein the market research is conducted according to a method comprising the steps of:
defining the company's major competitors;
interviewing customers and potential customers about customer needs, how the customer fulfills those needs, how competitors fulfill those needs, and the customer's loyalty to the company or one of its competitors;
analyzing current market opportunities by examining growth in the company's markets and the competition in those markets; and
summarizing the gathered data through a predetermined set of measures, graphs, and text.

4. The method of claim 2 further comprising the steps of:
acquiring corporate sponsors; and
coordinating the development of information technology and operation systems by the company and corporate sponsors.

5. The method of claim 2 further comprising the step of developing information technology and operation systems to support the set of products and programs.

6. The method of claim 2 further comprising the step of creating a new prospect database containing information about potential customers, the new prospect database being derived from customer referrals, acquired lists of potential customers, media outreach, and company seminars.

7. The method of claim 2 wherein the customer data is retrieved from the first database by a method comprising the steps of:
mapping the data structure of the first database;
specifying the customer data in the data structure of the first database; and
developing an interface program and a transfer program to move the customer database from the first database to a second database.

8. The method of claim 2 wherein the set of integrated customer data is created by a method comprising the steps of:
gathering a set of supplementary customer data through direct or indirect contact with customers;
combining the set of core customer data with the additional customer data to create an set of integrated customer data;
entering the set of integrated customer data into the second database using the interface program and the transfer program;
removing from the integrated set of customer data all redundant or unneeded entries and information;
identifying inconsistencies and missing information in the integrated set of customer data and resolving the inconsistencies and collecting the missing data through customer contact;
developing a process for updating the second database so that the set of integrated customer data contained in the second database remains consistent with the customer data in the first database;
developing a series of support procedures to keep the second database secure and ordered; and
linking the second database with the first database and all other customer databases to ensure data integrity as the respective databases are updated.

9. The method of claim 2 wherein the communication channel is selected according to a method comprising the steps of:
researching the company's communication activities by:
identifying communication channels available in the company's marketplace;
reviewing the effectiveness of previous use of the identified communication channels in the past; and
examining the communication channels in relation to the needs of the set of products and programs; and
selecting at least one of the identified communication channels.

10. A method for developing a comprehensive and integrated corporate marketing program to increase new customer acquisition and customer loyalty for a consumer services company comprising the steps of:
generating a target position for the company with respect to the company's market and the company's customer relationships;
developing a predetermined set of branding tools to cause the company to reach the target position;
developing a set of products and programs that support the set of branding tools and that facilitate the company in obtaining the target position;
developing a set of sales strategies for the set of products and programs;
creating a set of integrated customer data; and
using the integrated set of customer data to disseminate the set of products and programs created for the company to customers and potential customers.

11. The method of claim 10 wherein the target position for the company is generated according to a method comprising the steps of:
conducting market research about the company and producing a market report of the results; and
analyzing the market report to generate a target position for the company with respect to the company's market and the company's customer relationships.

12. The method of claim 11 wherein the market research is conducted according to a method comprising the steps of:
defining the company's major competitors;
interviewing customers and potential customers about customer needs, how the customer fulfills those needs, how competitors fulfill those needs, and the customer's loyalty to the company or one of its competitors;
analyzing current market opportunities by examining growth in the company's markets and the competition in those markets;
summarizing the gathered data through a predetermined set of measures, graphs, and text;
producing a market report that includes any results from the market research; and
analyzing the market report to generate the target position for the company.

13. The method of claim 10 further comprising the steps of:
acquiring corporate sponsors; and
coordinating the development of information technology and operation systems by the company and corporate sponsors.

14. The method of claim 10 further comprising the step of developing information technology and operation systems to support the set of products and programs.

15. The method of claim 10 further comprising the step of creating a new prospect database containing information about potential customers.

16. The method of claim 10 further comprising the step of integrating the set of products and programs into the company's existing products and programs.

17. The method of claim 10 further comprising the steps of:
retrieving a set of core customer data from a first database used by the company by
mapping the data structure of the first database;
specifying the customer data in the data structure of the first database; and
developing an interface program and a transfer program to move the customer database from the first database to a second database.

18. The method of claim 17 further comprising the steps of:
gathering a set of supplementary customer data through direct or indirect contact with customers;
combining the set of core customer data with the additional customer data to create an set of integrated customer data;
entering the set of integrated customer data into the second database using the interface program and the transfer program;
removing from the integrated set of customer data all redundant or unneeded entries and information;
identifying inconsistencies and missing information in the integrated set of customer data and resolving the inconsistencies and collecting the missing data through customer contact;
developing a process for updating the second database so that the set of integrated customer data contained in the second database remains consistent with the customer data in the first database;
developing a series of support procedures to keep the second database secure and ordered; and
linking the second database with the first database and all other customer databases to ensure data integrity as the respective databases are updated.

19. The method of claim 10 further comprising the steps of:
selecting a communication channel to inform current and potential customers of the set of products and programs; and
coordinating the use of the selected communication channel with existing company use of the selected communication channel and other communication channels.

20. The method of claim 19 wherein the communication channel is selected according to a method comprising the steps of:
researching the company's communication activities by:
identifying communication channels available in the company's marketplace;
reviewing the effectiveness of previous use of the identified communication channels in the past; and
examining the communication channels in relation to the needs of the set of products and programs; and
selecting at least one of the identified communication channels.

21. The method of claim 20 further comprising the step of developing the selected communication channel by producing promotional and informational materials for the channel.

22. The method of claim 20 further comprising the steps of:
using the selected communication channel to inform current and potential customers of the set of products and programs; and
coordinating the use of the selected communication channel with existing company use of the selected communication channel and other communication channels.
